(19) United States
(12) Patent Application Publication
(10) Pub. No.: US 2004/0023783 A1
(43) Pub. Date: Feb. 5, 2004

(54) Centrifuge

(76) Inventor: Willi Niemerg, Oelde (DE)

Correspondence Address: BARNES & THORNBURG, 750-17TH STREET NW, SUITE 900, WASHINGTON, DC, 20006, US

(21) Appl. No.: 10/433,831

(22) PCT Filed: Jan. 11, 2002
(86) PCT No.: PCT/EP02/00221

(30) Foreign Application Priority Data
Jan. 19, 2001 (DE) 101 02 253.0

(51) Int. Cl. B04B 1/14

(52) U.S. Cl. 494/70

(57) ABSTRACT

The invention relates to a centrifuge (or a separator) comprising a centrifugal drum (1) and a spring-loaded piston valve (5) that is guided in a drum bottom part (2) so as to be axially displaceable. Said piston valve (5) is maintained in a closed position by springs (7) that are supported on the drum bottom part (2), in which position solid discharge openings (6) provided in the jacket area (2a) of the drum bottom part (2f) are closed. A pressure is generated when a control medium is fed to an opening chamber (8) between the piston valve (5) and the centrifuge chamber bottom (3), which pressure overcomes the spring forces so that the piston valve (5) is displaced axially to such an extent that the solid discharge openings (6) are released. The springs (7) are produced from a non-alloy spring steel and are fully enclosed by cylinders (7) from a corrosion-resistant material. The invention allows for minimum dimensions of the springs (7) and their integration into the entire construction, high spring and thus closing forces and at the same times guarantees a complete insulation of the spring chamber relative to the sterile chamber.

The present invention relates to a centrifuge having a centrifugal drum which comprises a drum bottom part, a centrifuge chamber bottom, a drum cover and a piston valve, the piston valve being axially movably disposed in the drum bottom part as well as being held by springs supported at the drum bottom part in a closed position for solid-matter discharge openings provided in the jacket area of the drum bottom part, and being movable by a control medium, which can be introduced into an opening chamber arranged between the piston valve, on the one side, and the centrifuge chamber bottom, on the other side, against the effect of the springs into an opening position for the solid-matter discharge openings.

Centrifuges or separators of the above-mentioned type are basically known.

Reference is made here, for example, to U.S. Patent Document U.S. Pat. No. 4,164,317 as well as German Patent Document DE 30 09 669.

For hygienic reasons, springs made of stainless materials are used in the case of centrifuges or separators of the above-mentioned type.

Here, it is a disadvantage that, by using springs made of a stainless material, a relatively large space is required for the accommodation of the springs, because springs made of stainless materials in comparison to springs made of unalloyed spring steel require considerably larger dimensions while the forces are the same.

It is an object of the present invention to design a centrifuge of the above-mentioned type such that, while meeting all hygienic requirements, only a relatively small space is required for housing the springs.

According to the invention, this object is achieved in that the springs are made of an unalloyed spring steel and are encapsulated by sleeves made of a corrosion-resistant material which, on one side, project into the piston valve and, on the other side, into bores of the bottom area of the drum bottom part.

By means of this comparatively simple and cost-effective construction, on the one hand, a high closing force is achieved and, on the other hand, a large piston valve stroke is achieved while the space for accommodating the springs is minimal, at the same time, a perfect insulation of each spring chamber with respect to the sterile chamber being ensured.

An abrasion by friction under centrifugal force as well as corrosion influences upon the product are securely avoided.

Additional characteristics of the invention are the object of subclaims.

The attached drawings illustrate an embodiment of the invention which will be described in detail in the following.

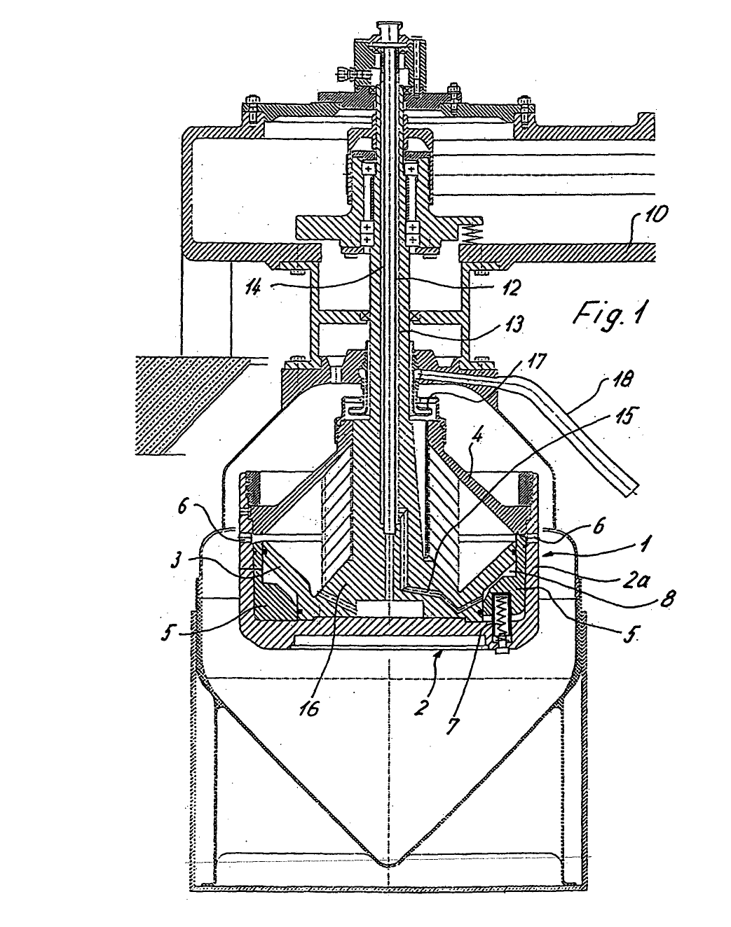

FIG. 1 is a sectional view of a centrifuge according to the invention having a piston valve;

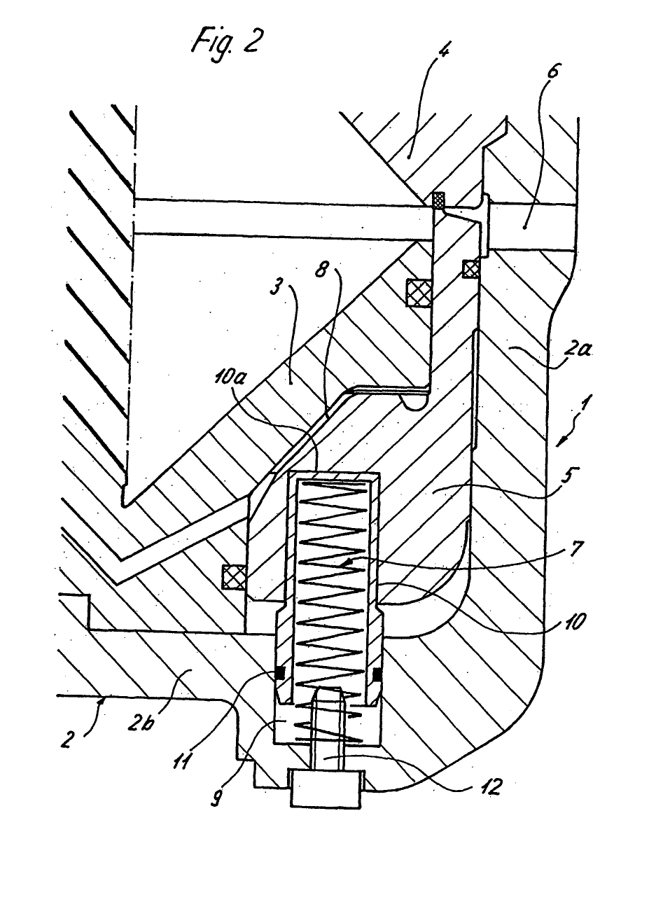

FIG. 2 is an enlarged view of the detail marked “II” in FIG. 1.

FIG. 1 illustrates a centrifuge having a centrifugal drum 1 which comprises a drum bottom part 2, a centrifuge chamber bottom 3, a drum cover 4 as well as a piston valve 5, the piston valve 5 being axially movably disposed in the drum bottom part 2.

The centrifuge constructed as a separator is suspended at a machine frame 10, in which case the material to be centrifuged is fed through a feeding tube 12 leading from above into the centrifugal drum 1. A tube 13 is arranged concentrically to the feeding tube, so that a control fluid, such as sterile control air, can be fed through the space 15 between the feeding tube 12 and the tube 13.

The space 14 leads into a passage 15 in the distributor 16, and this passage 15 leads into the opening chamber 8.

Material to be centrifuged is collected in a container 16 indicating the suspended centrifugal drum 11 (1? translator).

The liquid phase is discharged by way of the separating disk 17 and the pipe 18.

In the right-hand half of FIG. 1, the piston valve 5 is shown in a closed position;

that is, in this closed position the solid-matter discharge openings 6 provided in the jacket area 2a of the drum bottom part 2 are tightly closed by the piston valve 5. In the left-hand half of FIG. 1, the piston valve 5 is shown in the open position; that is, in this position, the solid-matter discharge openings 6 of the drum bottom part 2 are open.

As illustrated in the right-hand half in FIG. 1, the piston valve 5 is held in its closed position by means of several springs 7.

The opening position is achieved in that, as a result of the introduction of a control medium, preferably compressed air, into an opening chamber 8, which is formed between the control piston 5, on the one side, and the centrifuge chamber bottom 3, on the other side, a pressure is built up which overcomes the forces of the springs 7 and thereby moves the piston valve 5 into the opening position illustrated in the left-hand half of FIG. 1. When, inversely, the opening chamber 8 is depressurized again, the springs 7 move the piston valve 5 back into the closed position illustrated in the right-hand half of FIG. 1.

As illustrated particularly in the detail drawing according to FIG. 2, the springs 7, which according to the invention are made on an unalloyed spring steel, are encapsulated in sleeves 10 made of a corrosion-resistant material, which, on the one side project into the piston valve 5 and, on the other side, project into bores 9 of the bottom area 2b of the drum bottom part 2.

In this case, the sleeves 1 0 are advantageously closed on the face at their ends projecting into the piston valve 5, so that the springs 7 are supported by means of their ends projecting into the piston valve 5 on the frontal-area bottoms 10a of the sleeves 10 situated there.

In their sections projecting into the bores 9 of the drum bottom part 2, the sleeves are sealed off by means of at least one sealing ring 11 respectively with respect to the bores 9.

Furthermore, FIG. 2 clearly illustrates that the ends of the springs 7 projecting into the bores 9 of the drum bottom part 2 are guided on guide pins 12, while the remaining area of the springs 7 is secured by the above-mentioned sleeves 10 against lateral deflections.

As a result of the use of springs 7 made of an unalloyed spring steel, it becomes possible to provide a particularly space-saving construction so that, despite relatively small dimensions of the springs 7, large closing forces are achieved for the piston valve 5.

Likewise, a relatively large piston valve stroke can be implemented while the dimensions of the springs 7 are relatively small. By means of the encapsulation of the springs 7, a highly effective insulation of the spring chamber with respect to the sterile chamber is ensured, and an abrasion by friction or centrifugal force as well corrosion influences upon the product are reliably avoided.

1. Centrifuge having a centrifugal drum which comprises a drum bottom part, a centrifuge chamber bottom, a drum cover and a piston valve, the piston valve being axially movably disposed in the drum bottom part as well as being held by springs supported at the drum bottom part in a closed position for solid-matter discharge openings provided in the jacket area of the drum bottom part, and being movable by a control medium, which can be introduced into an opening chamber arranged between the piston valve, on the one side, and the centrifuge chamber bottom, on the other side, against the effect of the springs into an opening position for the solid-matter discharge openings,
characterized in that the springs (7) are produced from unalloyed spring steel and are encapsulated by sleeves (7) (10? translator) made of a corrosion-resistant material and projecting, on the one side, into the piston valve (5) and, on the other side, into bores (9) of the bottom area 2b) of the drum bottom part (2).

2. Centrifuge according to claim 1,
characterized in that the sleeves (7) are closed on the face at their ends projecting into the piston valve (5), and in that the face-side ends of the springs (7) projecting into the piston valve (5) are supported on face-side bottoms (10) of the sleeves (10).

3. Centrifuge according to claim 1 or 2,
characterized in that, in their sections projecting into the bores (9) of the drum bottom part (2), the sleeves (7) (10?) are sealed off by at least one sealing ring (11) respectively with respect to the bores (9).

4. Centrifuge according to one or several of the preceding claims,
characterized in that the ends of the springs (7) projecting into the bores (9) of the drum bottom part (2) are guided on guide pins (12).
